(19) United States
(12) Patent Application Publication
(10) Pub. No.: US 2009/0263156 A1
(43) Pub. Date: Oct. 22, 2009

(54) PROCESS CARTRIDGE DETACHABLY MOUNTABLE TO AN IMAGE FORMING APPARATUS

(76) Inventor: Christopher Paul MERCER, Dongara (AU)

Correspondence Address: BERENATO, WHITE & STAVISH, LLC, 6550 ROCK SPRING DRIVE, SUITE 240, BETHESDA, MD, 20817, US

(21) Appl. No.: 12/107,348

(22) Filed: Apr. 22, 2008

(51) Int. Cl. G03G 21/18

(52) U.S. Cl. 399/111

(57) ABSTRACT

A process cartridge comprising a photosensitive drum and at least one process member extending between two positioning members. In particular, the process cartridge is detachably mountable to an image forming apparatus. The a process cartridge is detachably mountable to an image forming apparatus, and contains a first positioning member, a second positioning member, a rotatable photosensitive drum extending between and connected to the first positioning member and second positioning member, and at least one process member extending between and connected to the first positioning member and second positioning member such that the distance between the rotatable photosensitive member and the process member is fixed by the first positioning member and the second positioning member. In a second embodiment, a housing member is adapted to contain toner, the housing member extending between the first and second positioning members such that any toner contained within is constrained directly by the first and second positioning members.

### FIELD OF THE INVENTION

The invention relates to a process cartridge comprising a photosensitive drum and at least one process member extending between two positioning members. In particular, the process cartridge is detachably mountable to an image forming apparatus.

### BACKGROUND TO THE INVENTION

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

Recently, home and office printing systems which print text and images on a medium such as paper comprise two components, a printer and a process cartridge. Typically, the process cartridge is mounted to the printer and is comprised of the elements of the printing system most frequently requiring replacement or repair.

These elements typically consist of ink or toner, rollers, blades, augers, drums, gears, fixings and the like. It is advantageous that these be placed in the process cartridge to facilitate economical replacement upon failure of any of the above-mentioned elements.

An electrophotographic printing system is a precise combination of many components, the elements of a process cartridge in a electrophotographic system must be precisely placed in order to function correctly. For example a developer roller in a process cartridge must be precisely spaced from a photosensitive drum to facilitate even transfer of toner therebetween, the same can be said for a combination of blades and rollers provided in the process cartridge.

Conventionally, a process cartridge has been formed by connecting the various elements to each other and surrounding them with a plastic housing. There is traditionally provided a point on the process cartridge that may receive a rotational driving force for rotating any elements in the process cartridge requiring rotation such as drums, rollers and the like. These rotatable elements are typically connected through a gear train to facilitate transfer of the rotational driving force between the said elements.

In the area of non-contact electrophotographic process cartridges that use magnetic toner it has long been recognised that control of the gap between the photosensitive drum and developer roller is critical to efficient and high-quality performance of the printing system. However, it is known that this gap may be affected by such factors as the non-circularity, non-concentricity or wear of the operable surface of either the photosensitive drum or the developer roller.

In seeking to alleviate the problems caused by such factors, typically process cartridges have been constructed such that either the photosensitive drum or the developer roller has a spacer provided at both ends thereof. Regulation of the distance of the gap between the photosensitive drum and the developer roller is then achieved by urging the two components together with the spacers setting the gap between their circumferences and hence tightly regulating the development gap of the electrophotographic system.

In order to achieve such urging there has traditionally been two methods of construction. In the first method of construction, the process cartridge consists of two assemblies that are swingingly engaged. One assembly supports a photosensitive drum and the other supports a developer roller with collar-like spacers at each end. Springs are employed so as to urge the two assemblies together with the photosensitive drum separated by the spacer collars from the developer roller and hence the developer gap is set between the two circumferences. An example of such a system is disclosed in U.S. Pat. No. 6,070,029 (Canon Kabushiki Kaisha).

In the second method of construction, the process cartridge consists of a lower assembly and an upper assembly. The lower assembly supports both the photosensitive drum and the developer roller, with an urging system to guide the developer roller towards the photosensitive drum. As with the first system, the developer roller has a spacer collar at each longitudinal end and hence the circumferences are separated in a spaced relationship.

The problems with both two-part construction methodologies is, firstly, that assembly of such process cartridges is dependent on spring forces and the precision of the spacer collars Further the spacer collars are prone to contamination by toner in the system. Furthermore, both methods require lateral mounting systems within the process cartridge for the electrophotographic components, especially the photosensitive drum and developer roller, in order to provide the lateral urging which is required to bring the drum and developer roller together into spaced relationship. This lateral supporting system requires the process cartridge to be substantially longer than the process width of the photosensitive drum. The process width is the maximum image width that the process cartridge can generate. This width is determined by the width of the photosensitive drum which can support a latent (electrostatic) image and also the toner supporting width of the developer roller, presented by the roller for development of the latent image.

With the increased demand by manufacturers to produce smaller printers (because of the reduced material costs) and the same increased demand from consumers for smaller printers (for space and aesthetic reasons), the ability to produce smaller process cartridges provides great benefits to both parties.

It is therefore an object of the present invention to provide a process cartridge having a very convenient method of controlling the space between components of the process cartridge.

It is a further object of the present invention to provide a process cartridge occupying very little excess space beyond the process width required to print.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

In accordance with a first embodiment of the present invention there is a process cartridge detachably mountable to an image forming apparatus, the process cartridge containing,
a first positioning member,
a second positioning member,
a rotatable photosensitive drum extending between and connected to the first positioning member and second positioning member,
at least one process member extending between and connected to the first positioning member and second positioning member such that the distance between the rotatable photosensitive member and the process member is fixed by the first positioning member and the second positioning member.

Preferably, the at least one process member is a rotatable developer roller or a rotatable primary charge roller.

More preferably, the rotatable photosensitive drum is adapted to receive an external driving force through a driving force receiving member provided at one longitudinal end of the rotatable photosensitive drum.

More preferably, at least one process member or rotatable photosensitive drum is partially located within an aperture located in at least one of the first positioning member or the second positioning member.

Preferably, the first positioning member or second positioning member is in the form of a metal plate.

More preferably, the process cartridge further comprises a housing member adjacent to the first and second positioning members. Preferably the housing member is a toner hopper adapted to contain toner.

Preferably, the housing member is a scavenger unit adapted to contain toner.

Preferably, the first positioning member or second positioning member is in the form of a thin metal plate.

Preferably, the distance between the first positioning member and the second positioning member is at most about 1.15 times that of the maximum process width of the process cartridge.

More preferably, the distance between the first positioning member and the second positioning member is at most about 1.10 times that of the maximum process width of the process cartridge.

More preferably, the process cartridge further comprises a housing member adjacent to the first and second positioning members.

Preferably, the housing member is a toner hopper adapted to contain toner. More preferably the housing member is a scavenger unit adapted to contain toner.

Preferably, the first positioning member or second positioning member is in the form of a metal plate.

In accordance with a second embodiment of the present invention there is a process cartridge detachably mountable to an image forming apparatus wherein the process cartridge containing,
a first positioning member,
a second positioning member,
a housing member adapted to contain toner, the housing member extending between the first and second positioning members such that any toner contained within is constrained directly by the first and second positioning members.

Preferably, the process cartridge further comprises at least two process members extending between and connected to the first and second positioning members such that the distance between the two process members is fixed.

More preferably at least one of the two process members is a rotatable photosensitive drum, a rotatable developer roller or a rotatable primary charge roller.

More preferably, at least one process member is adapted to receive an external driving force through a driving force receiving member provided at one longitudinal end of the process member.

More preferably, at least one process member is partially located within an aperture located in at least one of the first positioning member or the second positioning member.

Preferably, the first positioning member or second positioning member is in the form of a thin metal plate. More preferably, the housing member is a toner hopper adapted to contain toner.

More preferably, the housing member is a scavenger unit adapted to contain toner.

Preferably, the distance between the first positioning member and the second positioning member is at most about 1.15 times that of the maximum process width of the process cartridge.

More preferably, the distance between the first positioning member and the second positioning member is at most about 1.10 times that of the the maximum process width of the process cartridge.

Preferably, the housing member is a toner hopper adapted to contain toner. More preferably, the housing member is a scavenger unit adapted to contain toner.

### BRIEF DESCRIPTION OF THE DRAWINGS

The invention will now be described, by way of example only, with reference to the accompanying drawings, in which:

FIG. 1 is an exploded view of a process cartridge according to a first aspect of the present invention.

FIG. 2 is a side perspective view of a first positioning member of the process cartridge shown in FIG. 1.

FIG. 3 is a side perspective view of the bearing plate of the process cartridge shown in FIG. 1.

FIG. 4 is an exploded view of a process cartridge according to a second aspect of the present invention.

FIG. 5 is a plan view of the process cartridge shown in FIG. 1.

FIG. 6 is a side perspective view of an alternative first positioning member of a process cartridge according to the present invention.

### DETAILED DESCRIPTION OF THE INVENTION

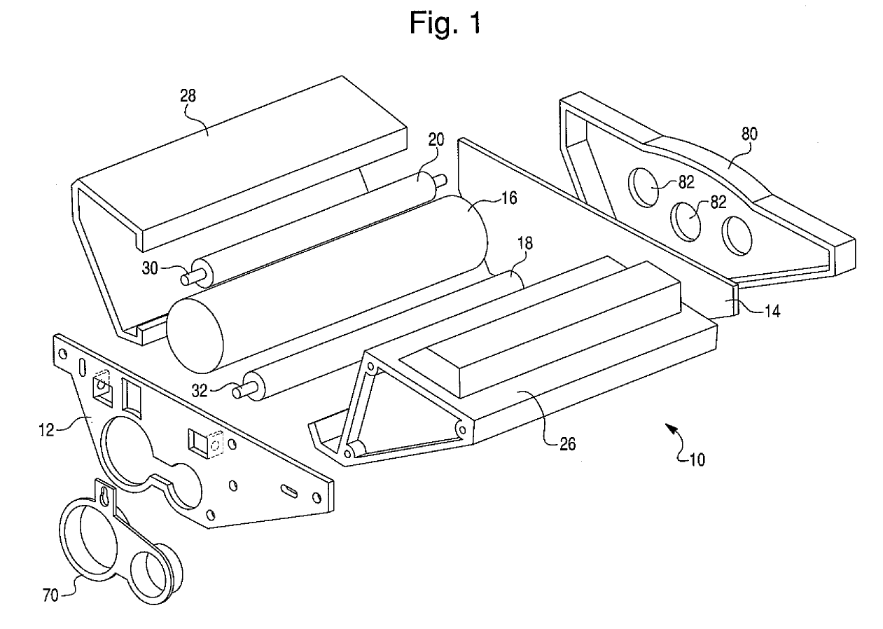

In accordance with a first embodiment of the invention there is a process cartridge 10 as shown in FIG. 1. The process cartridge 10 comprises a first positioning member 12 at one longitudinal end and a second positioning member 14 at an opposing longitudinal end. Extending between the first and second positioning members are the following process members: a photosensitive drum 16, a developer roller 18, a triboelectric blade (not shown), a cleaning blade (not shown) and a primary charge roller 20. Furthermore, the following housing members extend between the first and second positioning members; a toner hopper 26, a scavenger unit 28. Finally, a bearing plate 70 is removably connectable to the first positioning member 12, whilst a second bearing plate (not shown) may be connected to the second positioning member 14.

The primary charge roller 20 is rotatable and mounted around a shaft 30, similarly the developer roller 18 is rotatable and mounted around a magnet 32. The photosensitive drum 16 is rotatable, however it is not mounted around a shaft or magnet.

The photosensitive drum 16 is rotated by a driving force receiving member (not shown) located at one longitudinal end of the photosensitive drum 16. Similarly, the developer roller 18 is rotated by a driving force receiving member (not shown) located at one longitudinal end of the developer roller 18. Both the photosensitive drum 16 and developer roller 18 may be fitted with a concentric boss (not shown) at each longitudinal end to assist in supporting and mounting the photosensitive drum 16 and developer roller 18, as will be explained below. If the boss is provided at a longitudinal end of the photosensitive drum 16 or developer roller 18 that is intended to be driven, the boss may be adapted to receive a driving force. This may be through a gear such as a helical gear or spur gear or through a projection or recess. The primary charge roller 20 is rotated through contact with the rotating photosensitive drum 16.

The toner hopper 26 and scavenger unit 28 are formed from extruded plastic and form a housing in which toner can be securely stored. In the preferred embodiment, the toner hopper 26 and scavenger unit 28 are open ended such that the first and second positioning members 10, 12 provide the ends of the toner hopper 26 and scavenger unit 28. In this manner, if the toner hopper 26 and scavenger unit 28 are filled with toner (not shown) the toner directly contacts the first positioning member 10 and second positioning member 12.

The first and second positioning members 12 and 14 are preferably formed from punched metal, however any strong, rigid material may be used as would be obvious to a person skilled in the art.

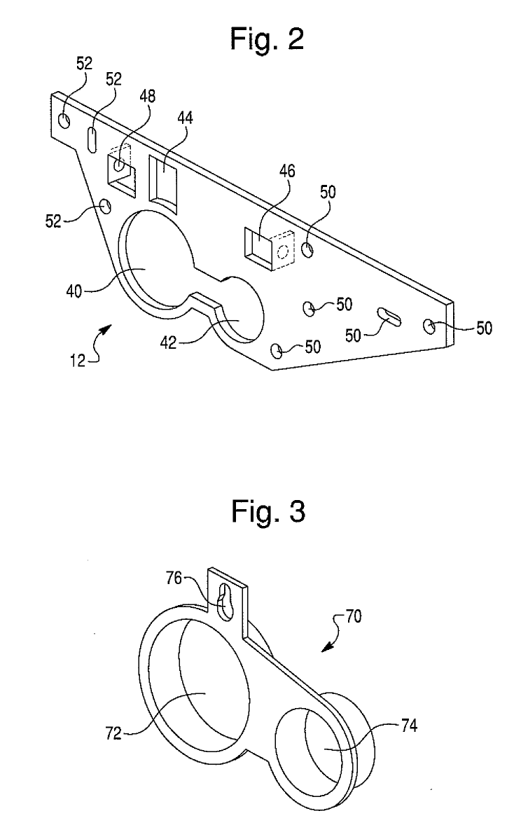

The process members are mounted directly to the first and second positioning members 12, 14 respectively so as to precisely locate their position. FIG. 2 provides a closer view of a typical first positioning member 12. The first positioning member 12 contains a photosensitive drum supporting portion 40, a developer roller supporting portion 42, a primary charge roller supporting portion 44, a triboelectric blade supporting portion 46, a toner hopper supporting portion 50 and a scavenger unit supporting portion 52.

The photosensitive drum supporting portion 40 is in the form of an aperture adapted to rotatably mount the photosensitive drum 12. The photosensitive drum 12 is thus precisely located through secure, close engagement of the concentric boss with the first positioning member 12 through the bearing plate 70 which will be described in detail shortly.

Similarly, the developer roller supporting portion 42 is in the form of an aperture adapted to rotatably mount the developer roller 18. The developer roller 18 is thus precisely located through secure, close engagement of the concentric boss with the first positioning member 12 through the bearing plate 70 which will be described in detail shortly.

The primary charge roller supporting portion 44 is a rectangular shaped aperture adapted to receive the primary charge roller 20 and thus securely locate the primary charge roller 20.

The triboelectric blade supporting portion 46 is adapted to receive a triboelectric blade, preferably the triboelectric blade supporting portion 46 is in the form of a bracket protruding from the first positioning member 12 so as to provide a platform to which a triboelectric blade may be secured. The cleaning blade supporting portion 48 is substantially similar to the triboelectric blade supporting portion 46.

The toner hopper supporting portion 50 is in the form of at least one aperture, so as to facilitate the joining of the toner hopper 26 to the first positioning member 12 through a screw, rivet or similar connecting member (not shown). Similarly, the scavenger unit supporting portion 52 is adapted to allow attachment of the scavenger unit 28 to the first supporting portion 12.

The bearing plate 70 is provided to provide rotational and longitudinal support to the photosensitive member 12, developer roller 18 and primary charge roller 20. The bearing plate 70 comprises three bearing retainers 72, 74 and 76. The apertures are provided for placement over the ends of the photosensitive member 12, developer roller 18 and primary charge roller 20 respectively. Once placed over the ends of the three process members, support is provided to secure the members in place and prevent lateral movement during use of the process cartridge 10 and rotation of the process elements.

The bearing plate 70 might also be adapted to provide electrical contact to one or more of the process elements that it supports.

The bearing plate 70 is made of a flexible but hard plastic. The bearing plate 70 has three bearing retainers 72, 74 and 76. Bearing retainer 72 projects from one side of the bearing plate 70 and is of a size to be securely retained within the photosensitive member supporting portion 40. Bearing retainer 74 projects from the same side of the bearing plate 70 and is of a size to be securely retained within the developer roller supporting portion 42. Bearing retainer 76 projects from the same side of the bearing plate 70 and is of a size to be securely retained within the primary charge roller supporting portion 44. However, while bearing retainers 72 and 74 provide a retaining opening similar in size and shape to that of the photosensitive member supporting portion 40 and developer roller supporting portion 42, to which they are received, the bearing retainer 76 has a wide base portion that is narrowed after a predetermined distance away from the bearing retainer 72.

Optional side covers may be placed over the ends of the process cartridge 10, such as the side cover 80.

The method of constructing the process cartridge 10 will now be described.

The bearing plate 70 is inserted into the first positioning member 12 such that the bearing retainers 72, 74 and 76 are received within the photosensitive drum supporting portion 40, developer roller supporting portion 42 and primary charge roller supporting portion 44.

The process members are then secured to the first positioning member in the following manner, the developer roller 18, photosensitive drum 16 and primary charge roller 20 are then inserted into bearing retainer 74, bearing retainer 72 and bearing retainer 76 respectively such that the drive force receiving members are provided at the non-inserted end.

The triboelectric blade is then securely affixed via the triboelectric blade supporting portion 46 to the first positioning member 12 using screws, glue or other fastening means.

The cleaning blade is then securely affixed via the cleaning blade supporting portion 48 to the first positioning member 12 using screws, glue or other fastening means.

Once all process members are secured to the first positioning member 12, the partially assembled process cartridge 10 is rotated such that the first positioning member 12 is substantially horizontal and the process members are extending vertically outwards from the first positioning member 12.

A fixture (not shown) can then be used to clamp the vertically extending process members into a predetermined position and hold them steady. The second positioning member 14 may then be placed over the ends of the process members furthest from the first positioning member 12, thus securing the process members in place between the first positioning member 12 and the second positioning member 14.

Next, the toner hopper 26 and scavenger unit 28 can be moved into position between the first positioning member 12 and second positioning member 14. The toner hopper 26 and scavenger unit 28 are first secured to the second positioning member 14 via screws or other fastening means. Then, the toner hopper 26 and scavenger unit 28 are secured to the first positioning member 12 via the toner hopper supporting portion 50 and scavenger unit supporting portion 52 using screws or other fastening means.

If desired, a side cover may be placed over either end of the cartridge 10, such as the side cover 80. The side cover 80 has apertures 82 to receive the photosensitive drum 16 and developer roller 18 (and their respective driving force receiving members).

Alternatively to the above method, all components of the cartridge 10 could be clamped by a fixture (not shown), in order to hold the components in a fixed position, prior to placement of the first positioning member 12, second positioning member 14, toner hopper 26 and scavenger unit 28.

In the described method, the combination of the accurate positioning of the supporting portions provided for in the first positioning member 12 and the additional flexibility provided by the bearing plate 70 allows for accurate control of the distance between the photosensitive drum 16 and the developer roller 18 when factors such as non-concentricity, non-circularity and wear come into play. It also allows for accurate positioning of the primary charge roller 20 relative to the photosensitive drum 16 and the developer roller 18.

Furthermore, the use of the combination of the first positioning member 12 and bearing plate 70 facilitates minimal variation between cartridge width and process width. The first embodiment of the present invention allows a ratio of the width of the cartridge to the process width of at most about 1.15. Meaning, the cartridge is at most about 1.15 times as wide as the process width. It also allows for simple construction of the cartridge compared to those cartridges in the prior art. Cartridge width is defined as the distance from the first positioning member to the second positioning member.

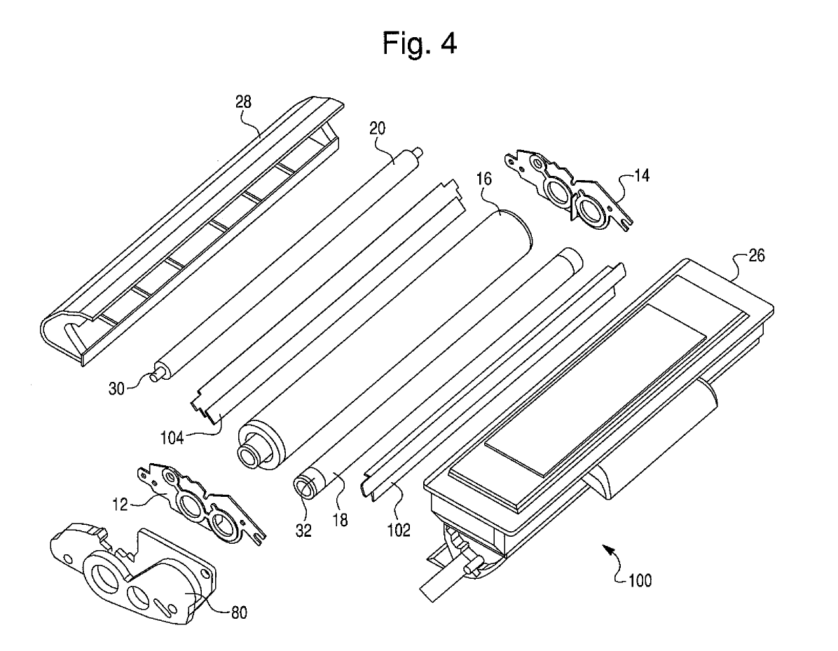

A second embodiment of the present invention has been further envisaged and is shown in FIG. 4, whereby a process cartridge 100 is provided having first and second positioning members 12 and 14 with process members extending therebetween. The process members are selected from a group consisting of a photosensitive drum 16, developer roller 18, primary charge roller 20, triboelectric blade 102 and a cleaning blade 104.

A toner hopper 26 and scavenger unit 28 are provided as separate units attached adjacent to the first and second positioning members 12 and 14. Therefore, the toner hopper 26 and scavenger unit 28 do not extend between the first positioning member 12 and the second positioning member 14.

In this embodiment the locations of the process members are precisely mounted using the first and second positioning members 12 and 14 as described for the first embodiment. Therefore the gap between the developer roller 18 and the photosensitive drum 16 is precisely controlled and the cartridge width is still kept to a minimum.

The process cartridge 100 shown in FIG. 4 shows the first positioning member 12 incorporating a bearing plate similar to the bearing plate 70 of the first embodiment of the present invention. It should be understood by a person skilled in the art that a bearing plate can be used as a separate member or incorporated in a positioning member without detrimentally affecting the function of the process cartridge.

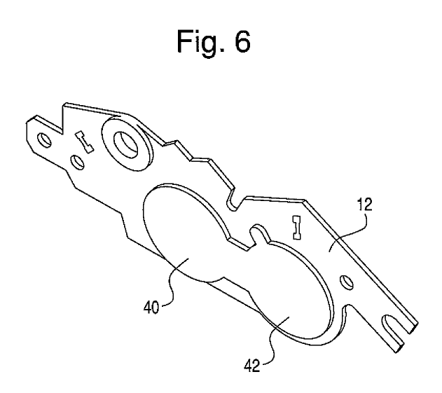

An alternative first positioning member 12 is shown in detail in FIG. 6, the first positioning member 12 contains a photosensitive drum supporting portion 40 and a developer roller supporting portion 42 adapted to receive the outer diameters of the photosensitive drum 16 and developer roller 18. The two portions 40 and 42 and the corresponding bearing retainers 72 and 74 are combined to form a shape substantially similar to a “figure 8”. When a photosensitive drum 16 and a developer roller 18 are supported within the supporting portions 40 and 42, the gap between the photosensitive drum 16 and developer roller 18 is precisely controlled by the supporting portions 40 and 42 limiting lateral movement of the drum 16 and roller 18. This alternative construction eliminates variations caused by non-concentricity of the bosses featured in the previous embodiments,

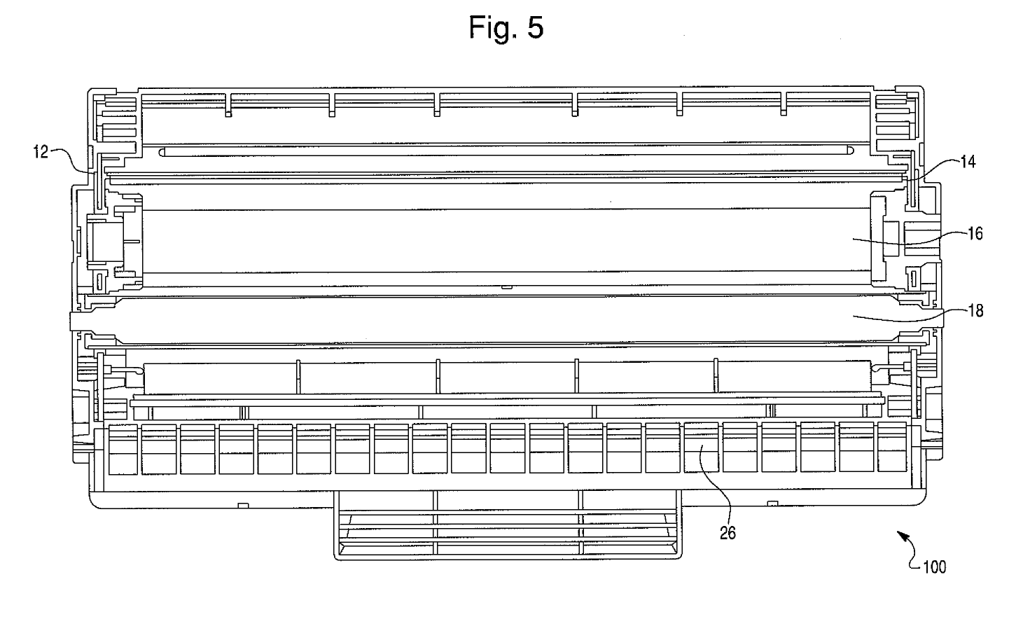

FIG. 5 demonstrates on example of the process cartridge 100 of FIG. 4, the distance between the first positioning member 12 and second positioning member 14 is 232.5 mm, while the process width (defined as the maximum printable width of the cartridge) is 222.5 mm. This results in a ratio of the distance between the first and second positioning member of 1.04 times the process width. This is just one example of a possible process cartridge using the present invention, it will be understood by a person skilled in the art that many such configurations are possible in order to facilitate printing of different paper types and page widths, whilst remaining under a maximum ratio of about 1.15.

All embodiments of the present invention defined above result in a cartridge construction whereby the distance between the first positioning member and the second positioning member is at most about 1.15 times that of the maximum process width of the process cartridge. More preferably all embodiments of the present invention result in a cartridge construction whereby the distance between the first positioning member and the second positioning member is at most about 1.10 times that of the maximum process width of the process cartridge.

All process cartridges described above are intended for use in a electrophotographic printing machine, as such any element typically placed within a electrophotographic printing machine can be placed within the process cartridge, these elements would be readily understood by a person skilled in the art.

Although the embodiments described above are directed to use directly within a electrophotographic printing machine, they are also suited for use within a mounting frame which may be removably mounted to a electrophotographic printing machine.

It should be further appreciated by the person skilled in the art that the features described above, where not expressly indicated to the contrary, are not mutually exclusive and that a combination of features may be produced to form yet further embodiments of the invention.

We claim:

1. A process cartridge detachably mountable to an image forming apparatus, the process cartridge containing,
a first positioning member,
a second positioning member,
a rotatable photosensitive drum extending between and connected to the first positioning member and second positioning member,
at least one process member extending between and connected to the first positioning member and second positioning member such that the distance between the rotatable photosensitive member and the process member is fixed by the first positioning member and the second positioning member.

2. A process cartridge according to claim 1, wherein the at least one process member is a rotatable developer roller or a rotatable primary charge roller.

3. A process cartridge according to claim 2, wherein the rotatable photosensitive drum is adapted to receive an external driving force through a driving force receiving member provided at one longitudinal end of the rotatable photosensitive drum.

4. A process cartridge according to claim 1, wherein at least one process member or rotatable photosensitive drum is partially located within an aperture located in at least one of the first positioning member or the second positioning member.

5. A process cartridge according to claim 4, wherein the first positioning member or second positioning member is in the form of a metal plate.

6. A process cartridge according to claim 1, further comprising a housing member adjacent to the first and second positioning members.

7. A process cartridge according to claim 6, wherein the housing member is a toner hopper adapted to contain toner.

8. A process cartridge according to claim 6, wherein the housing member is a scavenger unit adapted to contain toner.

9. A process cartridge according to claim 7, wherein the first positioning member or second positioning member is in the form of a thin metal plate.

10. A process cartridge according to claim 1, wherein the distance between the first positioning member and the second positioning member is at most about 1.15 times that of the maximum process width of the process cartridge.

11. A process cartridge according to claim 10, wherein the distance between the first positioning member and the second positioning member is at most about 1.10 times that of the maximum process width of the process cartridge.

12. A process cartridge according to claim 11, further comprising a housing member adjacent to the first and second positioning members.

13. A process cartridge according to claim 12, wherein the housing member is a toner hopper adapted to contain toner.

14. A process cartridge according to claim 12, wherein the housing member is a scavenger unit adapted to contain toner.

15. A process cartridge according to claim 13, wherein the first positioning member or second positioning member is in the form of a metal plate.

16. A process cartridge detachably mountable to an image forming apparatus wherein the process cartridge containing,
a first positioning member,
a second positioning member,
a housing member adapted to contain toner, the housing member extending between the first and second positioning members such that any toner contained within is constrained directly by the first and second positioning members.

17. A process cartridge according to claim 16, further comprising at least two process members extending between and connected to the first and second positioning members such that the distance between the two process members is fixed.

18. A process cartridge according to claim 17, wherein at least one of the two process members is a rotatable photosensitive drum, a rotatable developer roller or a rotatable primary charge roller.

19. A process cartridge according to claim 18, wherein at least one process member is adapted to receive an external driving force through a driving force receiving member provided at one longitudinal end of the process member.

20. A process cartridge according to claim 17, wherein at least one process member is partially located within an aperture located in at least one of the first positioning member or the second positioning member.

21. A process cartridge according to claim 15, wherein the first positioning member or second positioning member is in the form of a thin metal plate.

22. A process cartridge according to claim 15, wherein the housing member is a toner hopper adapted to contain toner.

23. A process cartridge according to claim 15, wherein the housing member is a scavenger unit adapted to contain toner.

24. A process cartridge according to claim 15, wherein the distance between the first positioning member and the second positioning member is at most about 1.15 times that of the maximum process width of the process cartridge.

25. A process cartridge according to claim 24, wherein the distance between the first positioning member and the second positioning member is at most about 1.10 times that of the maximum process width of the process cartridge.

26. A process cartridge according to claim 24, wherein the housing member is a toner hopper adapted to contain toner.

27. A process cartridge according to claim 25, wherein the housing member is a toner hopper adapted to contain toner.

28. A process cartridge according to claim 24, wherein the housing member is a scavenger unit adapted to contain toner.

29. A process cartridge according to claim 25, wherein the housing member is a scavenger unit adapted to contain toner.
